(19) United States
(12) Patent Application Publication
(10) Pub. No.: US 2023/0013599 A1
(43) Pub. Date: Jan. 19, 2023

(54) ADAPTIVE MAC ARRAY SCHEDULING IN A CONVOLUTIONAL NEURAL NETWORK

(71) Applicant: Black Sesame International Holding Limited, San Jose, CA (US)

(72) Inventors: Fen Zhou, San Jose, CA (US); Xiangdong Jin, Mountain View, CA (US); Chengyu Xiong, San Jose, CA (US); Zheng Qi, Cupertino, CA (US)

(73) Assignee: Black Sesame International Holding Limited

(21) Appl. No.: 17/370,854

(22) Filed: Jul. 8, 2021

(51) Int. Cl. G06N 3/04; G06N 3/063; G06F 7/544; G06F 7/50; G06F 7/523

(52) U.S. Cl. CPC G06N 3/0481; G06N 3/063; G06F 7/5443; G06F 7/50; G06F 7/523

(57) ABSTRACT

The present invention relates to convolution neural networks (CNN) and methods for improving computational efficiency of multiply accumulate (MAC) array structure Specifically, the invention relates to cutting of activation data into a number of tiles for increasing overall computation efficiency. The invention discloses techniques to cut an activation data into a plurality of tiles by using a 3-D convolution computation core and support bigger tensor sizes. Lastly, the invention provides adaptive scheduling of MAC array to achieve high utilization in multi-precision neural network acceleration.

### FIELD OF INVENTION

The present invention relates to convolution neural networks and methods of improving computational efficiency of multiply accumulate (MAC) array structure. More specifically, the invention relates to cutting of activation data into a number of tiles for increasing overall computation efficiency

### BACKGROUND

Convolutional neural network (CNN) is composed of multiple convolution layers. Each convolution layer in CNN is composed of convolutions. In this computation, the input activations of a layer are structured as a set of 2-D input data, each of which is a channel. Each channel is convolved with a distinct 2-D filter from a stack of filters, one for each channel; this stack of 2-D filter from the stack of filters is often referred to as a single 3-D filter The results of the convolution at each point are summed across all the channels. The result of this computation is the output activations that comprise one channel of output feature map. Additional 3-D filters can be used in the same input to create additional output channels. Finally, multiple input feature maps may be processed together as a batch to potentially improve reuse of the filter weights.

A convolution is the simple application of a filter to an input that results in an activation. Repeated application of the same filter to input results in a map of activations called as a feature map, indicates the location and strength of a detected feature in an input, such as an image.

In a convolution operation, the multiplication is performed between an array of input data and a two-dimensional array of weights, called a filter or a kernel. The filter is smaller than the input data and the type of multiplication applied between a filter-sized patch of the input and the filter is a dot product. A dot product is the element-wise multiplication between the filter-sized patch of the input and filter, which is then summed, always resulting in a single value.

A 2-D convolution ‘convolves’ along two spatial dimensions, It has a really small kernel, essentially a window of pixel values that slides along those two dimensions.

A 3D CNN is simply the 3D equivalent: It takes as input a 3D volume or a sequence of 2D frames 3D CNNs are a powerful model for learning representations for volumetric data. This model extracts features from both the spatial and the temporal dimensions by performing 3D convolutions, thereby capturing the motion information encoded in multiple adjacent frames. The developed model generates multiple channels of information from the input frames, and the final feature representation combines information from all channels,

Therefore to overcome the shortcomings of the prior-acts, there is need to provide an easily accessible and easy to use wearable device for rapid and self-administration of medicaments to the patients in need thereof.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described.

### SUMMARY OF THE INVENTION

Embodiments of the present invention relate to accelerating processing of an artificial neural network (ANN). Embodiments of the present invention describe convolution neural network (CNN) model, and a dedicated hardware accelerator designed to efficiently process it.

Convolutional neural networks (CNNs) are one of the most successful machine learning techniques for image, voice and video processing. CNNs require large amounts of processing capacity and memory bandwidth. Hardware accelerators have been proposed for CNNs which typically contain large numbers of multiply-accumulate (MAC) units, the multipliers of which are large in integrated circuit (IC) gate count and power consumption.

Neural network based perception application such as autonomous driving requires huge amount of convolution operations. MAC (multiplier accumulator) is the basic hardware element for convolution. The hardware accelerator comprises memory for storing inputs, a plurality of processor units each comprising a plurality of Multiply Accumulate (MAC) arrays and a filter weights memory associated with and common to the plurality of MAC arrays of one processor unit.

The convolution operation requires a lot of MAC operations. Each multiplication operation associates an input data value fluid a filter parameter, sometimes referred to as a ‘weight’. When the filter parameter is zero, the multiplication result is also zero. In this case, both parts of the MAC, which are multiple multiplications and successive additions, can be skipped without affecting the final result of the convolution.

The primary objective of the present invention is to cut input activation data and output activation data into several tiles in three dimensions. Activation data dimensions may be described as having an activation data map width (W), an activation data map height (H). where (W) and (H) form a two dimensional activation data area map (W×H). The addition of channel depth (D), changes the activation data area map to an activation data volume of (D×W×H), A batch (B) is a collection of (w×H×D) activation data volumes. The filter has a kernel width (Ky) a kernel height (Kx) a channel depth (0) and a number (N). The kernel width and kernel height form a kernel area (Ky×K×). The addition of channel depth (D) changes the kernel area to a kernel volume (Ky×Kx×D), a number (N) is a collection of (Ky×Kx×D) kernel volumes.

The method of cutting activation data, includes determining input tile width, input tile height, input tile depth, output tile width, output tile height and output tile depth based on activation data size, kernel size, MAC array size and local memory size.

Another objective of the present invention is to introduce a 3-D convolution computation core using configurable 1 or 2 or 4 MAC arrays that can perform a number of convolution operations. With these MAC arrays and adaptive MAC array scheduling hardware logics, convolution operations such as Multi-precision (4-bit, 8-bit), signed/unsigned convolution, de-convolution, dilated convolution, group convolution, and depth-wise convolution can be performed.

Another objective of the present invention is to provide adaptive scheduling of MAC array to achieve high utilization in multi-precision neural network acceleration. In the present invention, the 3D convolution core can adaptively schedule MAC arrays to work in different modes. In the Normal mode, all MAC arrays process same line and same input channels. Different MAC arrays process different output channels. The accumulator in MAC is used for input channel. In the 2-line mode, in the case of small tensor, all Mac arrays process two same lines and same input channels. Different MAC array process different output channels whereas all MAC arrays process four same lines and same input channels in the 4-line mode. Different MAC arrays process different output channels,

In the 2×2 spatial modes, two MAC arrays process even lines and different output channels, the other two MAC arrays process odd lines and different output channels whereas in the 4×1 spatial mode. each MAC array processes different line and same output channels. This mode can be used for group convolution and depth-wise convolution.

These and other objects and advantages will become apparent from the following description of several illustrative embodiments of the invention as shown in the following illustrative drawings,

Other objectives and aspects of the invention will become apparent from the following detailed description, taken in conjunction with the accompanying drawings, which illustrate, by way of example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments,

The presence of broadening words and phrases such as “one or more,” “at least,” “but not limited to” or other like phrases in some instances shall not be read to mean that the narrower case is intended or required in instances where such broadening phrases may be absent

### BRIEF DESCRIPTION OF DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of Us scope, the invention will be described and explained with additional specificity and detail through the use of the accompanying drawings in which:

FIG. 1A illustrates adaptive scheduling of MAC arrays in 8-bit normal mode;

FIG. 1B illustrates adaptive scheduling of MAC arrays in 8-bit 2-line mode;

FIG. 1C illustrates adaptive scheduling of MAC arrays in 8-bit 4-line mode;

FIG. 1D illustrates adaptive scheduling of MAC arrays in 8-bit 2×2 spatial mode;

FIG. 1E illustrates adaptive scheduling of MAC arrays in 8-bit 4×1 spatial mode;

FIG. 1F illustrates adaptive scheduling of MAC arrays in 4-bit normal mode;

FIG. 1G illustrates sequence of computations in a 3D MAC array in normal mode;

FIG. 2 illustrates a method of processing an activation data into a plurality of tiles by using a 3-D convolution computation core;

FIG. 3 illustrates a method of determining an output activation value in a convolutional neural network; and

FIG. 4 illustrates an exemplary multiply accumulate operation included as inputs,

### DETAILED DESCRIPTION

An exemplary hybrid computational system that may be used to implement neural nets includes processors that comprise a field programmable date array (FPGA), a graphical processor unit (GPU) and a central processing unit (CPU)

Each of the processing units, and has the capability of providing a neural net A CPU is a general processor that may perform many different functions, its generality leads to the ability to perform multiple different tasks, however, its processing of multiple streams of data is limited and its function with respect to neural networks is very limited. A GPU is a graphical processor which has many small processing cores capable of processing parallel tasks in sequence. An FPGA is a field programmable device, it has the ability to be reconfigured and perform in hardwired circuit fashion any function that may be programmed into a CPU or GPU. Since the programming of an FPGA is in circuit form, its speed is many times faster than a CPU and appreciably faster than a GPU.

There are other types of processors that the system may encompass such as an accelerated processing unit (APUs) which comprise a CPU with GPU elements on chip and digital signal processors (DSPs) which are specialized for performing high speed numerical data processing. Application specific integrated circuits (ASICs) may also perform the hardwired functions of an FPGA; however, the lead time to design and produce an ASIC is on the order of quarters of a year. not the quick turn-around implementation that is available in programming an FPGA.

The graphical processor unit, central processing unit and field programmable gate arrays are connected to each other and are connected to a memory interface and controller. The FPGA is connected to the memory interface through a programmable logic circuit to memory interconnect. This additional device is utilized due to the fact that the FPGA is operating with a very large bandwidth and to minimize the circuitry utilized from the FPGA to perform memory tasks. The memory and interface controller is additionally connected to persistent memory disk, system memory and read only memory (ROM).

The hybrid computational system may be utilized for programming and training the FPGA. The GPU functions well with unstructured data and may be utilized for training, once the data has been trained a deterministic inference model may be found and the CPU may program the FPGA with the model data determined by the GPU. The memory interface and controller is connected to a central interconnect, the central interconnect is additionally connected to the GPU, CPU and FPGA. The central interconnect is additionally connected to the input and output interface and the network interface

A second example of hybrid computational system that may be used to implement neural nets associated with the operation of one or more portions or steps of process. In this example. the processors associated with the hybrid system comprise a field programmable gate array (FPGA) and a central processing unit (CPU). The FPGA is electrically connected to an FPGA controller which interfaces with a direct memory access (DMA). The DMA is connected to input buffer and output buffer, both of which are coupled to the FPGA to buffer data into and out of the FPGA respectively. The DMA consists of two first in first out (FIFO) buffers one for the host CPU and the other for the FPGA, the DMA allows data to be written to and read from the appropriate buffer, On the CPU side of the DMA are a main switch which shuttles data and commands to the DMA. The DMA is also connected to an SDRAM controller which allows data to be shuttled to and from the FPGA to the CPU, the SDRAM controller is also connected to external SDRAM and the CPU. The main switch is connected to the peripherals interface. A flash controller controls persistent memory and is connected to the CPU.

The 3D convolution core of the invention can process 32*8*16*4=16384 (8-bit) or 32768 (4-bit) MAC operations in one cycle. The 3D convolution can be efficiently utilized for different tensor and kernel sizes. The 3D convolution core dynamically adapts to network topology changes on a per-layer basis while supporting graph-based layer fusion. The 3D computation core can be reshaped for high utilization based on layer dimension making it better than a 2D core which cannot be reshaped for high utilization.

Further, the 3D convolution core dynamically supports additionally computation performance gain through multi-precision quantization and sparsity-pruning which includes reducing the size of the neural network. The 3D convolution core does so without sparsity acceleration which wastes computing resources and energy as compared to fixed precision design. The multi-precision quantization method employed by the 3D core can uniform the hardware configurations for different layers to reduce computation overhead.

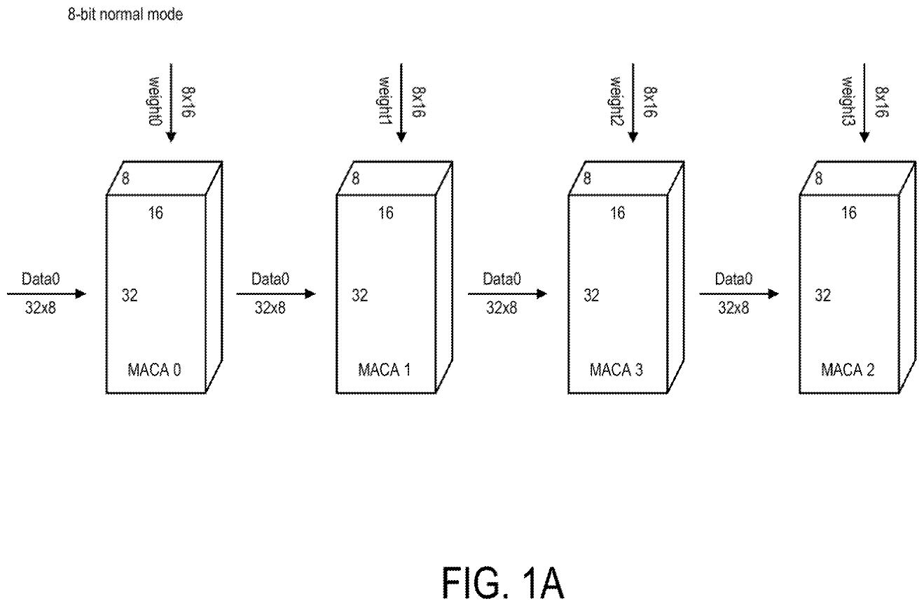

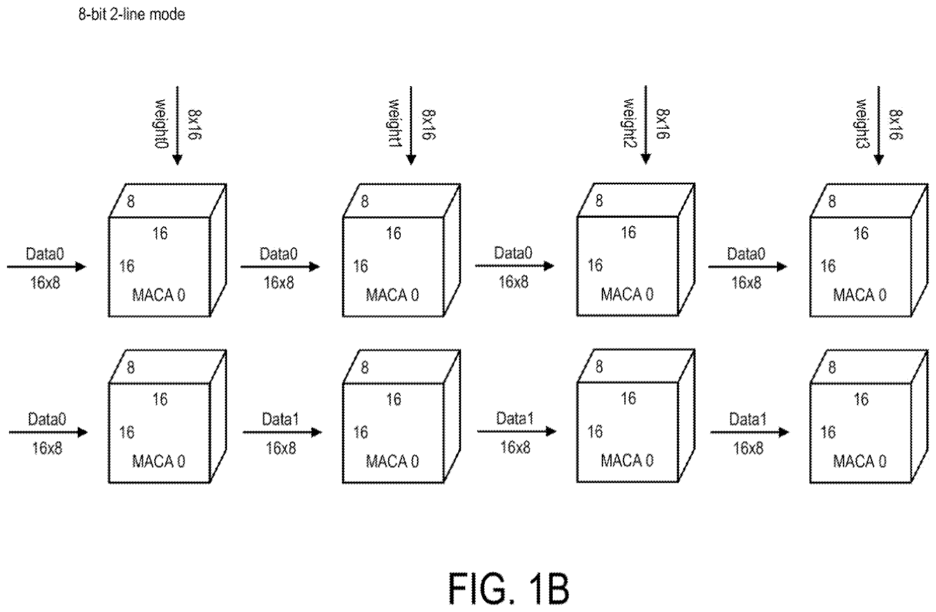

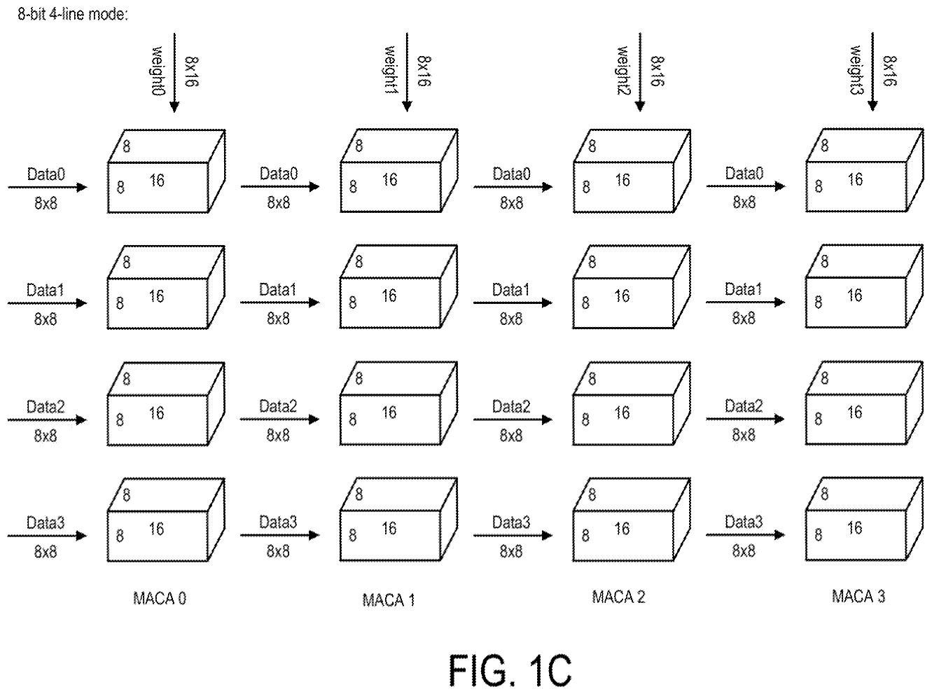

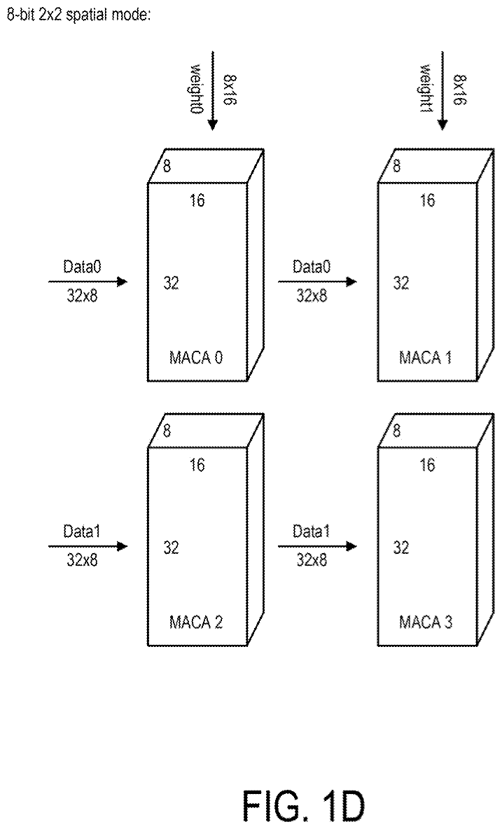

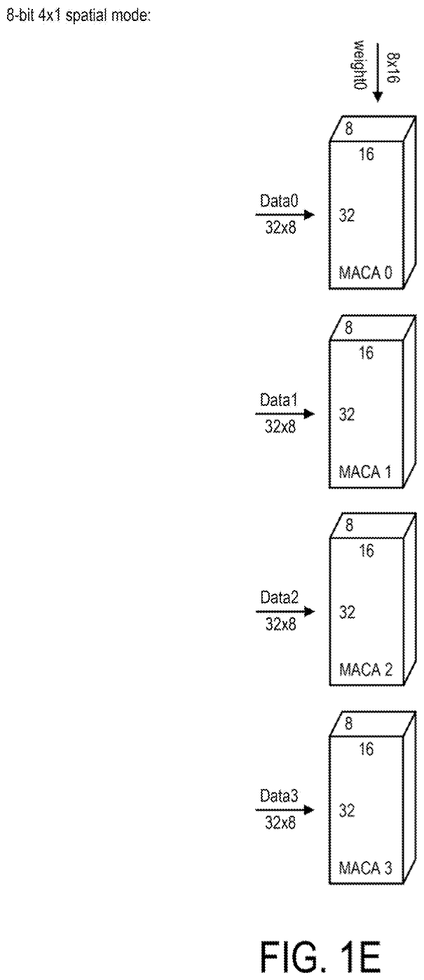

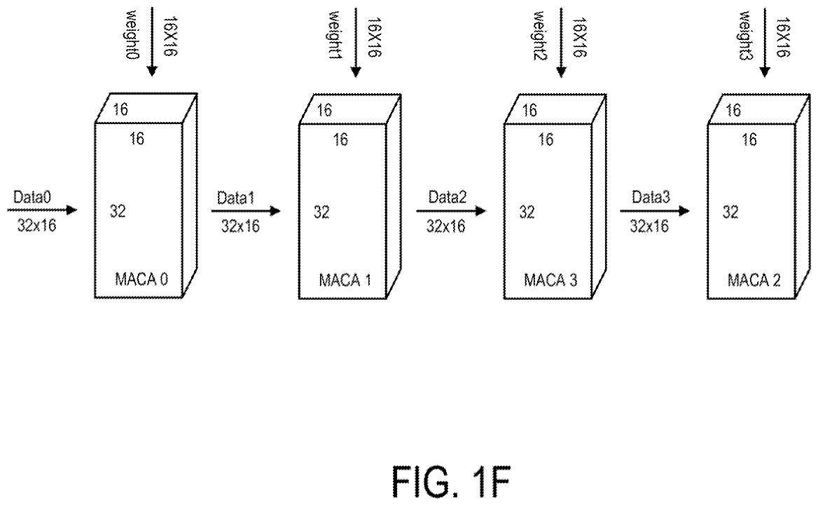

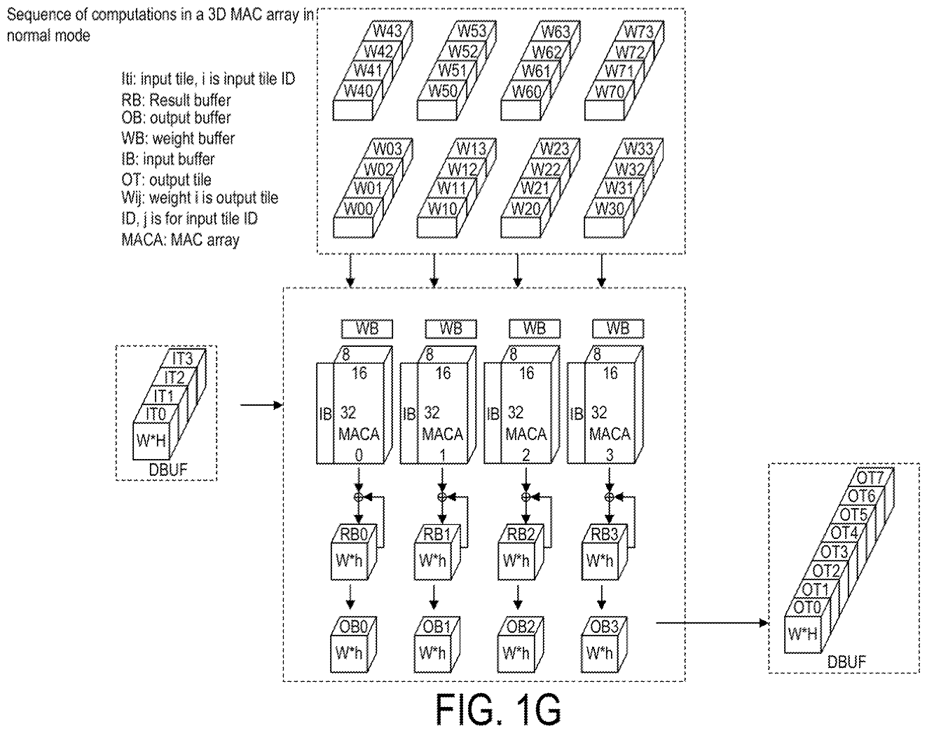

To support various tensor sizes and kernel sizes, and to make MAC utilization high, the convolution core can adaptively schedule MAC arrays to work in different modes. FIG. 1 illustrates the different modes as follows:

FIG. 1A illustrates adaptive scheduling of MAC arrays In 8-bit normal mode. In the Normal mode, all MAC arrays process same line and same input channels. Different MAC arrays process different output channels. The accumulator in MAC is used for input channel.

FIG. 1B illustrates adaptive scheduling of MAC arrays in 8-bit 2-line mode. In the 2-line mode, in the case of small tensor, all Mac arrays process two same lines and same input channels. Different MAC arrays process different output channels.

FIG. 1C illustrates adaptive scheduling of MAC arrays in 8-bit 4-line mode. All MAC arrays process four same lines and same input channels in the 8 bit 4-line mode as depicted in FIG. 5c, Different MAC arrays process different output channels.

FIG. 10 illustrates adaptive scheduling of MAC arrays in 8-bit 2×2 spatial mode. As illustrated in the 8bit 2×2 spatial mode of FIG. 5d, two MAC arrays process even lines and different output channels, the other two MAC arrays process odd lines and different output channels,

FIG. 1E illustrates adaptive scheduling of MAC arrays in 8-bit 4×1 spatial mode. In the 8bit 4×1 spatial mode of FIG. 5e each MAC array processes different line and same output channels. This mode can be used for group convolution and depth-wise convolution.

FIG. 1F illustrates adaptive scheduling of MAC arrays in 4-bit normal mode, In the Normal mode, all MAC arrays process same fine and same input channels. Different MAC arrays process different output channels. The accumulator in MAC is used for input channel.

FIG. 1G illustrates the sequence of computations in a 3D MAC array in normal mode. The sequence begins with multiplying an input tile IT0 with different weights W00, W10, W20 and W30. The result of the multiplication operations are stored in the result buffers RB0, RB1, RB2 and RB3 respectively. Next, input tile IT1 is multiplied with weights W01 W11, W21 and W31. The mentioned multiplication operations are added to the stored outputs in RB0, RB1, RB2 and RB3. The output of this operation is stored in the result buffers RB0, RB1, RB2 and RB3 which get updated.

A similar process follows for input tile IT2 which is multiplied with weights W02, W12, W22 and W32, the result of which is added to output of result buffers. The added result is then stored in result buffers RB0, RB1, RB2 and RB3 which update themselves again. Input tile IT3 is multiplied with weights W03, W13, W23 and W33. The multiplication output gets added to the output of the result buffers. The addition of the two gets stored in output tiles OT0, OT1, OT2 and OT3.

The input tile IT0 is of different weights W50. W50, W60 and W70. The result of the multiplication operations are stored in the result buffers RB0, RB1, RB2 and RB3 respectively, Next, input tile IT1 is multiplied with weights W41, W51, W61 and W71. The mentioned multiplication operations are added to the stored outputs in RB0, RB1, RB2 and RB3. The output of this operation is stored in the result buffers RB0, RB1, RB2 and RB3 which get updated.

A similar process follows for input tile IT2 which is multiplied with weights W42, W52, W62 and W72, the result of which is added to output of result buffers. The added result is then stored in result buffers RB0, R81, RB2 and RB3 which update themselves again. Input tile IT3 is multiplied with weights W43, W53, W63 and W73. The multiplication output gets added to the output of the result buffers. The addition of the two gets stored in output tiles OT4, OT5, OT6 and OT7.

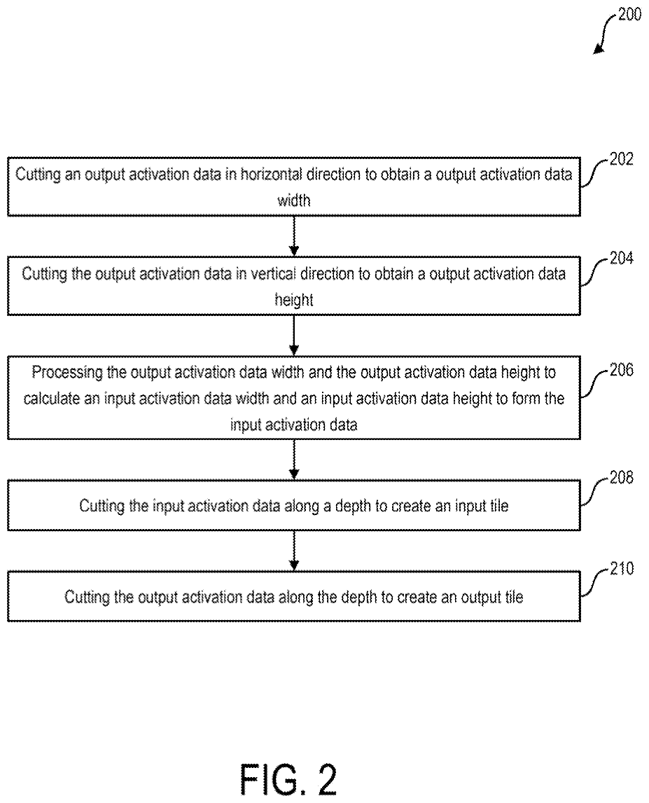

FIG. 2 illustrates a method of processing an activation data into a plurality of tiles by using a 3-D convolution computation core. To support bigger tensor sizes, tensor is cut into several tiles in three dimensions. Thus, these tiles can be fit into MAC arrays on chip memories. In channel direction, MAC results are added together to achieve final results. The tile size is determined by MAC array size, kernel size, stride, local memory size and local memory bandwidth.

The method includes the step of cutting an output activation data in horizontal direction to obtain a output activation data width 202. The step 202 involves setting the width of the tile based on the MAC array data size and cutting the output activation data based on the said MAC array data size. If there is more than one tile in horizontal dimension and the last output tile width is too small, the width of the second last tile is set to half of the MAC array data size i e 16 and 16 is added to the original last output tile.

The next step includes cutting an output activation data in vertical direction to obtain an output activation data height 204, The step 204 involves setting the height of the tile based on the local buffer size and cutting the output activation data in the vertical direction based on the set tile height. If more than one tile is in vertical dimension, the average of second last and last tile height is computed and the tile height is made 4 times of the original tile height. This is good for line mode and spatial mode

Further, processing of the output activation data width and the output activation data height is done to calculate an input activation data width and an input activation data height 206,

The input activation data can be calculated according to the given formula:

itile_width=otile_width*stride+wt_width−stride−pad_l−pad_r

itile_height=otile_height*stride+wt_height−stride−pad_l−pad_r

Next. the input activation data is cut along its depth to create an input tile in step 208. The step 208 involves setting normal input tile depth to 16 or 32 or 64 based on the local buffer size. Finally, the output activation data is cut along its depth to create an output tile in step 210. If there is only one MAC array, the output activation channel dimension is cut into several output tiles based on normal output tile depth, If there are two MAC arrays, the output activation channel dimension is cut into several output loops based on normal output tile depth. Then each output loop is further cut into 2 output tiles. Each MAC array has one output tile. Next, the output tile depth is chosen as a multiple of 16 wherein 16 is the MAC array filter number. If there are four MAC arrays, the output activation channel dimension is cut into several output loops. Further, each output loop is cut into 4 output tiles. Each MAC array has one output tile. The output tile depth is set so that it is a multiple of 16 which is MAC array filter number.

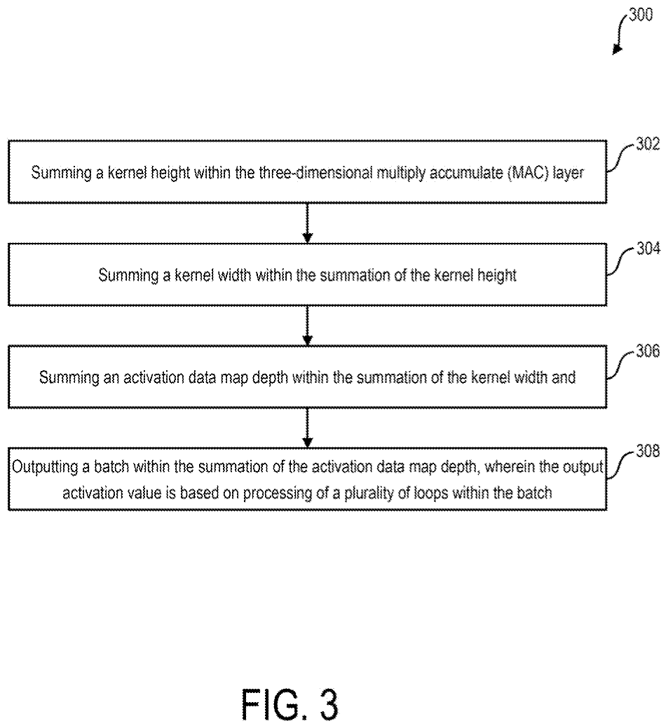

FIG. 3 illustrates a method of determining an output activatio value in a convolutional neural network.

The method performs summation operations inside multiple nested loops to compute an activation data value. The multiply accumulate operation comprises step 302, i.e. summation of a kernel height within the adaptive multiplier layer This is followed by summing a kernel width within the summation of the kernel height, as step 304.Thererafter, summation of an activation data map depth within the summation of the kernel width is performed as step 306. Finally, outputting a batch within the summation of the activation data map depth. where the output activation value is based on processing of a plurality of loops within the batch, as step 308.The summing is a series of nested loops in which one set of summations is done within the next outer loop summation. The method of FIG. 3 can be illustrated by the nested loop shown below.

```
A general convolution equation can be written as:
for (ou_ch_id=0; ou_ch_id<ou_channels; ou_ch_id++) {
for(ou_y_id=0; ou_y_id<ou_height; ou_y_id++) {
for(ou_x_id=0; ou_x_id<ou_weight; ou_x_id++) {
ou_data[ou_ch_id][ou_y_id][ou_x_id] = bias[ou_ch_id];
for(wt_y_id=0; wt_y_id<wt_height; wt_y_id++) {
for(wt_x_id=0; wt_x_id<wt_width, w_x_id++) {
for(in_ch_id=0; in_ch_id<in_channels, in_ch_id++) {
  din = in_data[in_ch_id][stride*ou_y_id+wt_y_id][stride*ou_x_id+wt_x_id]
  w = wt[ou_ch_id][in_ch_id][wt_y_id][wt_x_id];
ou_data[ou_ch_id][ou_y_id][ou_x_id] += din * w;
        }
      }
    }
  }
}
The convolution equation after adding tiles can be shown as: (XYZ means WHD)
for (otile_id_x=0; otile_id_x<otile_num_x; otile_id_x++) {
for (otile_id_y=0; otile_id_y<otile_num_y; otile_id_y++) {
  for (oloop_id=0; oloop_id<oloop_num; oloop_id++} {
  for (maca_id=0; maca_id<maca_num; maca_id++) {
for (itile_id_z=0; itile_id_z<itile_num_z; itile_id_z++) {
for (out_y_id=0; out_y_id<otile_height; out_y_id++) {
for (wt_grp_id=0; wt_grp_id<wt_grps_per_output_tile; wt_grp_id++) {
for (ch_grp_id=0; ch_grp_id<ch_grps_per_input_tile; ch_grp_id++) {
for (wt_y_id=0; wt_y_id<wt_height; wt_y_id++) {
for (wt_x_id=0; wt_x_id<wt_width; wt_x_id++) {
do_maca ( );  //input multiplier and adder
                  }
                }
              }
            }
          }
        }
      }
    }
  }
}
In above equation:
wt_grps_per_output_tile = otile_size_z / 16;
ch_grps_per_input_tile = itile_size_z / 8
```

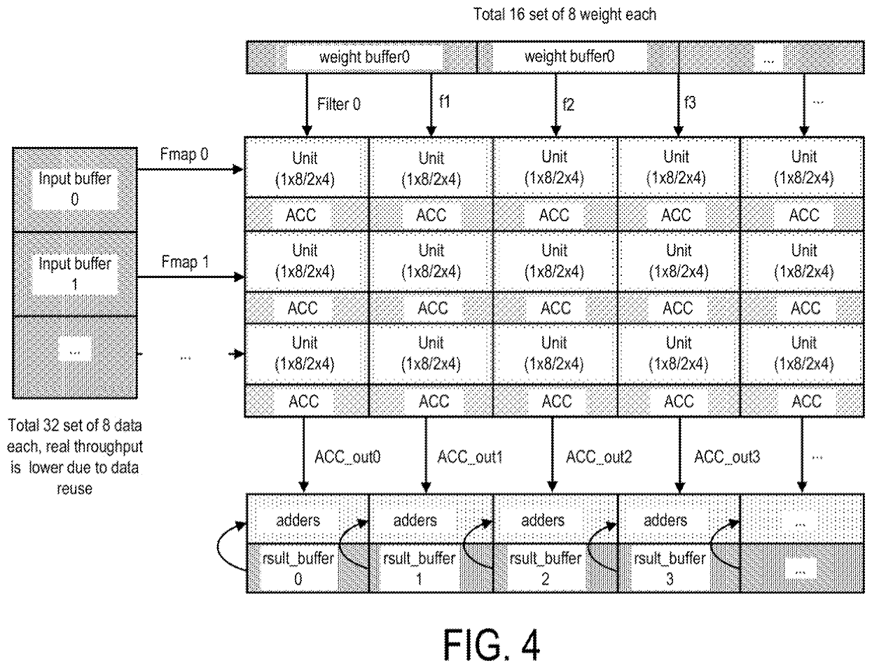

FIG. 4 illustrates an exemplary multiply accumulate operation included as inputs. Moreover, the inputs include input weight buffers and input activation data buffers. The multiply and accumulate cycles occur within the operation and then accumulation outputs are sent to adders and result buffers,

In one example, the activation data size may be 32×32×32×32(W×H×D×B) where the activation data area is 32 (W) by 32 (H) having a channel depth of 32 (D), giving the activation data a volume of 32×32×32 (D×W×H) and there are 32 batches (B) of activation data volume to consider.

The filter size may be 1×1×32×64 (Ky×Kx×D×N), where the filter width is 1, the filter height is 1, giving the kernel area as 1 (Ky) by 1 (Kx) and achannel depth (D), giving the kernel volume of 1×1×32 (Ky×Kx×D) and there are 64 (N) number of kernel volumes to consider. A vector of 16 multipliers may be implemented in one dimension to fully utilize a MAP cycle. Within a 32×32×32×32 (W×H×D×B). 16 multipliers applied to processing half of the 32-channel depth (D) dimension of the remaining portion of the activation data (W×H×B)in a cycle, the loop time of the channel depth is reduced from 32 to 2.

An array of two dimensional multipliers implemented as an array of 16×16 (D×N) multipliers applied to the 32×32×32×32 (W×H×D×B) activation data may decrease the processing by half of the channel depth 32D and by three quarters of the Number 64N of the filter loop which is 1×1×32×64 (Ky×Kx×D×N), this implementation of two dimensional multipliers reduces the channel loop from 32 to 2 and filter set loop from 64 to 4.

The 1-D or 2-D approach may suffer utilization issues if the layer dimensions are not sufficiently large to take advantage of the reductions or if the layer dimensions are very large and require a many multipliers. For example, to process 4096 multiplies per cycle, either 4096 one dimensional multipliers (D) or 64×64 two dimensional multipliers (D×N) would be needed.

If the activation data and filter weights are the same, the efficient utilization of multipliers may present difficulties. In the previous example, when the array of 32D×64N is utilized, this provides a utilization which is half of the desired performance goal.

One possible solution to this problem is the use of an adaptive three dimensional 3D array of multipliers. Adaptive indicating that the shape of the 3D array of multipliers may be adjusted based on the shape of the layer.

In one example an array of 32×8×16 (W×B×N) may be utilized. If the activation data map width is not a multiple of 32, then the 32 (W) may be utilized to concurrently determine both the activation data map width (W) and activation data map height (H). In this situation (W×H) will unroll the (W×H) two loops into one loop and divide it by 32. This allows an activation data map width (W) of 16 by an activation data height (H) of 16, i.e. 16×16 (W×H) to be fully utilized.

In the example above of the adaptive array of 32×8×16 (W×D×N), the second dimension 8(D) may cover the loops for D×Ky×Kx. in the case where the channel depth (D) is 4, which is common for a first convolution layer with RGBA having tour channels, the adaptive 3D array may concurrently determine the 4 channel depth (D), and 1× of the 1× kernel width (Ky) and the 1× kernel height (Kx) to achieve full utilization.

One of the objectives of the present invention is to provide adaptive scheduling of MAC array to achieve high utilization in multi-precision neural network acceleration, In the present invention, the 3D convolution core can adaptively schedule MAC arrays to work in different modes.

While, the various embodiments of the present invention have been described above, it should be understood that they have been presented by way of example only, and not of limitation. Likewise, the figure may depict an example architectural or other configuration for the invention, which is done to aid in understanding the features and functionality that can be included in the invention. The invention is not restricted to the illustrated example architectures or configurations, but the desired features can be implemented using a variety of alternative architecture and configurations.

Although, the invention is described above in terms of various exemplary embodiments and implementations. it should be understood that the various features, aspects and functionality described in one or more of the individual embodiments are not limited in their applicability to the particular embodiment with which they are described, but instead can be applied., alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

1. A method of processing an activation data into a plurality of tiles by using a 3-D convolution computation core, wherein the method comprising:
cutting an output activation data in horizontal direction to obtain a output activation data width;
cutting the output activation data in vertical direction to obtain a output activation data height;
processing the output activation data width and the output activation data height to calculate an input activation data width and an input activation data height to form the input activation data;
cutting the input activation data along a depth to create an input tile; and
cutting the output activation data along the depth to create an output tile.

2. The method according to claim 1, wherein cutting the output activation data and the input activation data is determined by size of the MAC array.

3. The method according to claim 1, wherein cutting the output activation data and the input activation data is determined by size of a kernel of the MAC array.

4. The method according to claim 1, wherein cutting the output activation data and the input activation data is determined by size of a local memory of the MAC array

5. The method according to claim 1, wherein cutting the output activation data and the input activation data is determined by a local memory bandwidth of the MAC array.

6. The method according to claim 1, wherein cutting the output activation data arid the input activation data is determined by a kernel stride of the MAC array.

7. The method according to claim 1, wherein height of the first tile is based on a lncal buffer size of the MAC array. B. The method according to claim 1, wherein width of the first tile is based on data size of the MAC array.

9. The method according to claim 1, wherein depth of the first tile is based on the local buffer size.

10. The method according to claim 1, wherein depth of the second tile is based on the local buffer size.

11. A method of determining an output activation value in a convolutional neural network of a BST chip, the method comprising:
summing a kernel height within the three-dimensional multiply accumulate (MAC) layer;
summing a kernel width within the summation of the kernel height
summing an activation data map depth within the summation of the kernel width; and
outputting a batch within the summation of the activation data map depth, wherein the output activation value is based on processing of a plurality of loops within the batch.

12. The method of providing the convoluted output in accordance with claim 11, wherein the plurality of loops are eight in count,

13. The method in accordance with claim 11, wherein the multiply accumulate (MAC) layer is a three-dimensional multiply accumulate (MAC) layer.

14. The method in accordance with claim 11, wherein the multiply accumulate (MAC) layer is an adaptive multiply accumulate (MAC) layer.

15. The BST chip in accordance with claim 11, is A500, A1000 and A1000L.
